(19) United States
(12) Patent Application Publication
(10) Pub. No.: US 2026/0115642 A1
(43) Pub. Date: Apr. 30, 2026

(54) THREE-DIMENSIONAL (3D) HYDROPHOBIC AMINE-RICH METAL ORGANIC FRAMEWORK WITH A HIGH SELECTIVITY FOR HUMID CO2 CAPTURE

(71) Applicant: Svante Technologies Inc., Burnaby (CA)

(72) Inventors: Vaidhyanathan RAMANATHAN, Pune Maharashtra (IN); Himan Dev SINGH, Pune Maharashtra (IN)

(73) Assignee: Svante Technologies Inc., Burnaby, BC (CA)

(21) Appl. No.: 19/124,845

(22) PCT Filed: Oct. 26, 2023
(86) PCT No.: PCT/IB2023/060803

§ 371 Date: Apr. 25, 2025

(30) Foreign Application Priority Data
Oct. 27, 2022 (IN) 202221061108

(51) Int. Cl. B01D 53/04; B01J 20/22; B01J 20/34

(52) U.S. Cl. CPC B01D 53/0462; B01J 20/226; B01J 20/3425; B01J 20/3483; B01D 2253/204; B01D 2257/504

(57) ABSTRACT

The present disclosure relates to metal organic frameworks (MOFs). Specifically, the present disclosure relates to a Copper(I)-Melamine based Three-Dimensional hydrophobic MOF with a high selectivity for CO₂ from humid atmospheres, and a method of synthesizing the same. Further, the disclosure relates to a method for capturing CO₂ from humid atmospheres using said 3D hydrophobic MOF.

### FIELD OF THE INVENTION

The present disclosure relates to metal organic frameworks (MOFs). Specifically, the present disclosure relates to a Three-Dimensional (3D) hydrophobic amine-rich melamine-based MOF with a high selectivity for CO₂ from humid atmospheres, and a method of synthesizing the same. Further, the disclosure relates to a method for capturing CO₂ from humid atmospheres using said 3D hydrophobic MOF.

### BACKGROUND OF THE INVENTION

Background description includes information that may be useful in understanding the present disclosure. It is not an admission that any of the information provided herein is prior art or relevant to the presently claimed invention, or that any publication specifically or implicitly referenced is prior art.

Carbon dioxide (CO₂), a greenhouse gas, is often targeted for removal from natural gas and other industrial gas streams. Conventional methods for removing carbon dioxide is often a costly and multi-stage process since such gas streams must be dehydrated first before CO₂ capture. The reason for the same is because water vapor interacts strongly with porous materials that exhibit physiosorption towards CO₂.

Metal-organic frameworks have already been identified as a potential candidate for separating CO₂ from gas mixtures such as CO₂/N₂, CO₂/H₂, CO₂/CH₄, CH₄/N₂ etc. A few hundred MOFs have been reported with capacities>3 mmol/g CO₂ uptake and selectivities of >100. Importantly, amine-functionalized MOF are suited for selective capture of CO₂. However, four major requirements keep them away from reaching application possibilities: (1) Water/steam stability, (2) Selective capture of CO₂ from humid gas streams and (3) Chemical Stability and (4) Cost-effectiveness. To our knowledge, no single MOF with the capacity and selectivity mentioned above meets all these other material requirements. Replacing competitive sorbents such as zeolites and carbons for industrial CO₂ capture by MOF is impossible unless these are met.

Therefore, there is an imminent need to design a MOF that is superhydrophobic, yet has a superior CO₂ capturing ability from humid atmosphere.

The present disclosure satisfies the existing needs, as well as others, and generally overcomes the deficiencies found in the prior art.

### OBJECTS OF THE INVENTION

Objects of the present disclosure relate to provide a MOF that is superhydrophobic, yet is functionalized for a superior CO₂ capturing ability from humid atmosphere.

An object of the present disclosure is to provide a 3D hydrophobic amine-rich MOF with a high selectivity for CO₂ from humid atmosphere.

Another object of the present disclosure is to provide a method of synthesizing 3D hydrophobic amine-rich MOF with a high selectivity for CO₂ from humid atmosphere.

Yet another object of the present disclosure is to provide a method for capturing CO₂ from humid atmospheres using said 3D hydrophobic MOF.

### SUMMARY OF THE INVENTION

This summary is provided to introduce a selection of concepts in a simplified form that is further described below in the detailed description section. This summary is not intended to identify key features or essential features of the claimed subject matter, nor is it intended to be used as an aid in determining the scope of the claimed subject matter.

The present disclosure relates to metal organic frameworks (MOFs). Specifically, the present disclosure relates to a Three-Dimensional (3D) hydrophobic amine-rich MOF with a high selectivity for CO₂ from humid atmospheres, and a method of synthesizing the same. Further, the disclosure relates to a method for capturing CO₂ from humid atmospheres using said 3D hydrophobic MOF.

In one aspect, the present disclosure relates to a 3D hydrophobic MOF that may be characterized by the formula MN(ORG)(OH)·(SOLVENT)ₓ, wherein MN is metal node-Cu(I); ORG is organic ligand-melamine; x is from 0 to 10 and SOLVENT is one or more of DMF.

In a preferred aspect, the present disclosure relates to a 3D hydrophobic MOF that may be characterized by the formula Cu(C₃N₃H₆)(OH)·(DMF/H₂O)ₓ, wherein, x is from 0 to 10.

In a preferred aspect, the present disclosure relates to a 3D hydrophobic MOF that an optimal concentration of charge-balancing hydroxide ions in the pores to ensure >3 mmol/g of CO₂ uptake at RT with a CO₂/N₂ selectivity of ˜300, which remains the same for the entire loading (zero to >3 mmol of CO₂).

In another aspect, the present disclosure relates to a method of synthesizing 3D hydrophobic MOF, said method comprising the steps of:
effecting a solvothermal reaction between metal framework source, organic ligand framework source, and terephthalic acid in organic solvent, followed by cooling to room temperature to obtain reaction product;
filtering reaction product to obtain block shaped pale green crystals of 3D hydrophobic MOF;
sonicating the block shaped pale green crystals in organic solvent, followed by filtering to remove unreacted terephthalic acid; and
washing with copious amounts of alkanol to obtain 3D hydrophobic MOF.

In yet another aspect, the present disclosure relates to a method for sorbing CO₂ form humid atmospheres, said method comprises the steps of:
a. contacting the MOF disclosed herein with a fluid or gas stream containing H₂O, CO₂, CH₄, N₂, H₂, and the like, wherein CO₂ is sorbed on the MOF; and
b. optionally regenerating the MOF for next CO₂ sorbing cycle.

Various objects, features, aspects and advantages of the inventive subject matter will become more apparent from the following detailed description of preferred embodiments.

### BRIEF DESCRIPTION OF THE DRAWINGS

The following drawings form part of the present specification and are included to further illustrate aspects of the present disclosure. The disclosure may be better understood by reference to the drawings in combination with the detailed description of the specific embodiments presented herein.

FIG. 1 represents the structure solved from single crystal X-ray diffraction showing, (A) The trigonal coordination around the Cu(I) center by three melamine moieties. (B) Uniform 1-D channels in the IISERP-MOF22 (1) lined by the amine groups of the melamine. The free hydroxyl groups in the channels are not shown for clarity. (C) The structure of the MOF showing the view along a-axis wherein the ordered hydroxide ions in the channels are shown in red. Color code: Zn-cyan; C-grey; N-blue; O-red; H-white.

FIG. 2 represents the Comparison of the powder X-ray diffraction pattern simulated from the single crystal data with the experimentally obtained one showing the phase purity.

FIG. 3 represents the TGA carried out on the 3D hydrophobic MOF.

FIG. 4 represents the adsorption isotherms carried on the 3D hydrophobic MOF.

FIG. 5 represents the pore width of the 3D hydrophobic MOF estimated by the NLDFT fit to the adsorption branch of 273k CO₂ isotherm.

FIG. 6 represents the IAST selectivity calculated for different gas mixture in 3D hydrophobic MOF.

FIG. 7 represents the Heat of adsorption calculated for 3D hydrophobic MOF using two different methods.

FIG. 8 represents the Volumetric CO₂ cycling performed on 3D hydrophobic MOF showing the recyclability of MOF

FIG. 9 represents the Gravimetric CO₂ cycling performed on 3D hydrophobic MOF showing the recyclability of MOF.

FIG. 10 represents the CO₂/N₂ breakthrough carried on 3D hydrophobic MOF at a total flow rate of 25 ml/minute (20 ml CO₂+5 ml N₂).

FIG. 11 represents the CO₂/N₂ breakthrough cycles showing no loss in the retention time after multiple cycles.

FIG. 12 represents the Water sorption isotherm of 3D hydrophobic MOF showing the poor interaction of water molecules with the MOF.

FIG. 13 represents the PXRD of the 3D hydrophobic MOF treated under different conditions showing the exceptional stability of the MOF.

### DETAILED DESCRIPTION OF THE INVENTION

The following is a detailed description of embodiments of the disclosure. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In some embodiments, numbers have been used for quantifying weight percentages, ratios, and so forth, to describe and claim certain embodiments of the invention and are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Various terms as used herein are shown below. To the extent a term used in a claim is not defined below, it should be given the broadest definition persons in the pertinent art have given that term as reflected in printed publications and issued patents at the time of filing.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context requires otherwise, throughout the specification which follow, the word “comprise” and variations thereof, such as, “comprises” and “comprising” are to be construed in an open, inclusive sense that is as “including, but not limited to.”

The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified.

The description that follows, and the embodiments described therein, is provided by way of illustration of an example, or examples, of particular embodiments of the principles and aspects of the present disclosure. These examples are provided for the purposes of explanation, and not of limitation, of those principles and of the disclosure.

It should also be appreciated that the present disclosure can be implemented in numerous ways, including as a system, a method or a device. In this specification, these implementations, or any other form that the invention may take, may be referred to as processes. In general, the order of the steps of the disclosed processes may be altered within the scope of the invention.

The headings and abstract of the invention provided herein are for convenience only and do not interpret the scope or meaning of the embodiments.

The following discussion provides many example embodiments of the inventive subject matter. Although each embodiment represents a single combination of inventive elements, the inventive subject matter is considered to include all possible combinations of the disclosed elements. Thus if one embodiment comprises elements a, b, and c, and a second embodiment comprises elements b and d, then the inventive subject matter is also considered to include other remaining combinations of a, b, c, or d, even if not explicitly disclosed.

As used herein, the term “humid atmosphere” refers to one or more of a gas, liquid, or combination thereof. A gas or liquid may include one or more components. For example, humid atmosphere may include a gas stream including H₂O, CO₂. CH₄, N₂, H₂, and the like.

As used herein, the term “capturing” or “capture” refers to the act of removing one or more chemical species from a bulk fluid composition (e.g., gas/vapor, liquid, and/or solid). For example, “capturing” may include, but is not limited to, interacting, bonding, diffusing, adsorbing, absorbing, reacting, and sieving, whether chemically, electronically, electrostatically, physically, or kinetically driven.

As used herein, “carbon dioxide” and/or “CO₂” may include solid, liquid, and/or gas/vapor phases.

The present disclosure relates to metal organic frameworks (MOFs). Specifically, the present disclosure relates to a Three-Dimensional (3D) hydrophobic MOF with a high selectivity for CO₂ from humid atmospheres, and a method of synthesizing the same. Further, the disclosure relates to a method for capturing CO₂ from humid atmospheres using said 3D hydrophobic MOF.

MOFs comprise a network of nodes and ligands, wherein a node has a connectivity capability at three or more functional sites, and a ligand has a connectivity capability at two functional sites each of which connect to a node. Nodes are typically metal ions or metal containing clusters, while ligands are organic ligands. The particular combination of metal nodes and organic ligands within a framework will dictate the framework topology and functionality.

In some embodiments of the present disclosure, the 3D hydrophobic MOF may be characterized by the formula MN(ORG)(OH)·(SOLVENT)x, wherein MN is metal node; ORG is organic ligand (otherwise known as organic framework); x is from 0 to 10; and SOLVENT is an organic solvent.

In an embodiment of the present disclosure, the metal node (otherwise known as metal framework) is preferred from metal salts such as nitrates, chlorides, sulphates, acetates, hydroxides, oxides, acetylacetonates, bromides, carbonates, carboxylates, tartrates and perchlorates. Preferably metal nitrate. More preferably copper nitrate.

In an embodiment of the present disclosure, the SOLVENT is organic solvent is selected from but not limited to dimethyl sulfoxide (DMSO), N,N-dimethylformamide (DMF), N,N-diethylformamide (DEF), N,N-dimethyl-acetamide (DMAc), acetonitrile, toluene, dioxane, benzene, chlorobenzene, methyl ethyl ketone (MEK), pyridine, tetrahydrofuran (THF), ethyl acetate, and the like. Most preferably DMF.

In an embodiment of the present disclosure, the 3D hydrophobic MOF may exhibit one or more of a high removal efficiency and/or high uptake, even at low concentrations of CO₂. For example, the 3D hydrophobic MOF may exhibit a removal efficiency of greater than about 50%, greater than about 75%, but not less than about 90%. In many embodiments, the 3D hydrophobic MOF exhibit a removal efficiency of greater than about 90%. For example, the 3D hydrophobic MOF may exhibit a removal efficiency of at least 91%, at least 92%, at least 93%, at least 94%, at least 95%, at least 96%, at least 97%, at least 98%, at least 99%, and/or at least 99.9%.

In an embodiment of the present disclosure, the 3D hydrophobic MOF lacks any strongly polar oxygen in the framework, which makes the material have a negligible affinity to water-evidenced by TGA and water sorptions.

In another embodiment, the present disclosure provides a method of synthesizing 3D hydrophobic MOF, said method comprising the steps of:
effecting a solvothermal reaction between metal framework source, organic ligand framework source, and terephthalic acid in organic solvent, followed by cooling to room temperature to obtain reaction product;
filtering reaction product to obtain block shaped pale green crystals of 3D hydrophobic MOF;
sonicating the block shaped pale green crystals in organic solvent, followed by filtering to remove unreacted terephthalic acid; and
washing with copious amounts of alkanol to obtain 3D hydrophobic MOF.

In an embodiment of the present disclosure, the metal framework source is selected but not limited to copper nitrate trihydrate.

In an embodiment of the present disclosure, the organic ligand framework source is selected but not limited to melamine.

In an embodiment of the present disclosure, the ratio of metal ion source and ligand source ranges from about 0.1:1 to 1:0.1, respectively. Most preferably the ratio is 1:1.

In an embodiment of the present disclosure, the organic solvent is selected from DMF, EtOH, NMP, and MeOH. Most preferably DMF.

In an embodiment of the present disclosure, the alkanol is selected from methanol, ethanol, n-propanol, isopropanol, n-butanol, isobutanol, t-butanol, pentanol, hexanol and mixtures thereof. Most preferably methanol.

In an embodiment of the present disclosure, the 3D hydrophobic MOF may be characterized by the formula MN(ORG)(OH)·(SOLVENT)ₓ, wherein MN is metal node-Cu(I); ORG is organic ligand-melamine; x is from 0 to 10 and SOLVENT is one or more of DMF.

In another embodiment, the present disclosure provides a method of synthesizing 3D hydrophobic MOF, said method comprising the steps of:
effecting a solvothermal reaction between copper nitrate trihydrate, melamine, and terephthalic acid in DMF, followed by cooling to room temperature to obtain reaction product;
filtering reaction product to obtain block shaped pale green crystals of 3D hydrophobic MOF;
sonicating the block shaped pale green crystals in organic solvent, followed by filtering to remove unreacted terephthalic acid; and
washing with copious amounts of methanol to obtain 3D hydrophobic MOF.

The MOF does not form without terephthalic acid, in fact, the Cu2+ reduces to Cu(0), metallic copper. The terephthalic acid can be replaced by oxalic acid, and the same Cu MOF is obtained but in relatively lower yields. The terephthalic/oxalic acid seem to be crucial in ensuring that the Cu2+ does not reduce all the way to Cu(0). Importantly, these dicarboxylic acids do not form any competing phases under these reaction conditions, but merely act as a redox control.

In an embodiment of the present disclosure, the ratio of copper nitrate trihydrate and melamine ranges from about 0.1:1 to 1:0.1, respectively. Most preferably the ratio is 1:1.

In an embodiment of the present disclosure, the concentration of copper nitrate trihydrate ranges from about 0.1 mmol to 1 mmol. For example, 0.1 mmol. 0.2 mmol, 0.3 mmol, 0.4 mmol, 0.5 mmol, 0.6 mmol, 0.7 mmol, 0.8 mmol, 0.9 mmol, or 1.0 mmol.

In an embodiment of the present disclosure, the concentration of melamine ranges from about 0.1 mmol to 1 mmol. For example, 0.1 mmol. 0.2 mmol, 0.3 mmol, 0.4 mmol, 0.5 mmol, 0.6 mmol, 0.7 mmol, 0.8 mmol, 0.9 mmol, or 1.0 mmol.

In an embodiment of the present disclosure, the concentration of terephthalic acid ranges from about 0.1 mmol to 1 mmol. For example, 0.1 mmol. 0.2 mmol. 0.3 mmol, 0.4 mmol, 0.5 mmol, 0.6 mmol, 0.7 mmol, 0.8 mmol, 0.9 mmol, or 1.0 mmol.

In an embodiment of the present disclosure, the solvothermal reaction is performed at 90° C. to 150° C. More preferably 120° C.

In an embodiment of the present disclosure, the solvothermal reaction is performed for 48 hrs to 96 hrs. More preferably 72 hrs.

In preferred embodiment of the present disclosure, the 3D hydrophobic MOF may be characterized by the formula Cu(C₃N₃H₆)(OH)·(DMF)x·(H₂O)_{y}, wherein, x is from 0 to 0.5 and y is from 0 to 0.2.

In an embodiment of the present disclosure, the yield of the 3D hydrophobic MOF is greater than about 50%, greater than about 60%, but not less than about 70%. In many embodiments, the yield greater than about 65%. For example, at least 65%, at least 66%, at least 67%, at least 68%, at least 69%, at least 70%, at least 72%, at least 73%, at least 74%, and/or at least 75%.

In yet another embodiment, the present disclosure provides a method for sorbing CO₂ form humid atmospheres, said method comprises the steps of:
c. contacting the MOF disclosed herein with a fluid or gas stream containing H₂O, CO₂, CH₄. N₂, H₂, and the like, wherein CO₂ is sorbed on the MOF; and
d. optionally regenerating the MOF for next CO₂ sorbing cycle.

In one embodiment of the present disclosure, the CO₂ capturing comprises the step of contacting 3D hydrophobic MOF with a fluid or gas stream including H₂O, CO₂, CH₄, N₂, H₂, and the like. In an embodiment, the contacting may include bringing the metal-organic framework and fluid composition into physical contact, or immediate or close proximity. Examples of the contacting may include, but are not limited to, one or more of feeding, flowing, passing, pumping, and introducing.

In an embodiment of the present disclosure, the CO₂ capturing further comprises optional step of regenerating the 3D hydrophobic MOF. The regenerating may include thermal treatment in a vacuum and/or inert gas environment (e.g., under nitrogen).

In an embodiment of the present disclosure, the contacting may proceed under any suitable conditions (e.g., temperature, pressure, etc.). For example, the contacting may proceed to or at a temperature ranging from about 25° C. to about 200° C. In many embodiments, the contacting may proceed at or to a temperature less than about 200° C. In preferred embodiments, the contacting may proceed at or to a temperature of about 25°−35° C. (e.g., about room temperature).

In an embodiment of the present disclosure, the concentration of CO₂ in the gas stream may range from about 0% to about 99.9%. In many embodiments, the concentration of CO₂ in the fluid composition is less than about 10%. In preferred embodiments, the concentration of CO₂ in the fluid composition is in the range of about 3 to about 50%. The material is stable to 100% CO₂ stream as well.

In an embodiment of the present disclosure, the 3D hydrophobic MOF has amine-lined channels and an optimal concentration of charge-balancing hydroxide ions in the pores to ensure >3 mmol/g of CO₂ uptake at RT with a CO₂/N₂ selectivity of ˜300.

In an embodiment of the present disclosure, the 3D hydrophobic MOF has water/steam stability, chemical stability and is more economical.

In an embodiment of the present disclosure, the MOF is synthesized as a pure phase in bulk as seen from PXRD, the MOF retains all its functional groups as evidenced from the IR spectra, the MOF is stable up to 280° C. as evidenced from TGA, the post-treatment PXRD confirms that the MOF is stable to treatment with water and even boiling in water, it is stable to a range of solvents including DMF. THF. Methanol, ethanol, toluene, etc., the MOF is stable steam and water, the MOF exposed to flue gas (generated from burning Coal) retains its crystallinity and porosity.

While the foregoing description discloses various embodiments of the disclosure, other and further embodiments of the invention may be devised without departing from the basic scope of the disclosure. The invention is not limited to the described embodiments, versions or examples, which are included to enable a person having ordinary skill in the art to make and use the invention when combined with information and knowledge available to the person having ordinary skill in the art.

### EXAMPLES

The present disclosure is further explained in the form of following examples. However, it is to be understood that the foregoing examples are merely illustrative and are not to be taken as limitations upon the scope of the invention. Various changes and modifications to the disclosed embodiments will be apparent to those skilled in the art. Such changes and modifications may be made without departing from the scope of the invention.

### Example 1: Synthesis of 3D Hydrophobic MOF

A solvothermal reaction between copper nitrate trihydrate (0.1 mmol), melamine (0.1 mmol), and terephthalic acid (0.1 mmol) in 5 ml DMF was carried out at 120° C. for 72 hours. After cooling to room temperature, block shaped pale green crystals of 1 were obtained by filtration. Isolated yield was ˜70%. The product was sonicated in DMF and filtered again to wash all the unreacted terephthalic acid. Finally it was washed with copious amounts of methanol to obtain 3D hydrophobic MOF.

### Example 2: Characterization of 3D Hydrophobic MOF from Example 1

The bulk phase purity was determined from Powder X-ray diffraction and the structure was solved from single crystal X-ray diffraction. Other routine characterizations such as Thermal analysis. IR-spectral analysis and porosity measurements have been performed. The sample is very pure. Importantly, the oxidation state of the copper in the MOF is established to be +1 from XPS analysis. In the as-made sample, the solvent is mostly DMF and some adsorbed water molecules. Once activated by heating under vacuum, there is hardly any solvent. The activated samples hydrophobicity is well established from contact angle measurements and water adsorption isotherms. The material shows good thermal and chemical stability.

### Single Crystal X-Ray Diffraction:

Single-crystals data were collected on a Bruker SMART APEX four-circle diffractometer equipped with a CMOS photon 100 detector (Bruker Systems Inc.) and with a Mo Kα radiation (0.71 Å). The incident X-ray beam was focused and monochromated using Micro focus (IμS). Crystal of 1 was mounted on nylon Cryo loops with Paratone-N oil. Data was collected at 100(2) K. Data was integrated using Bruker SAINT Software and was corrected for absorption using SADABS. Structure was solved by Intrinsic Phasing module of the direct methods and refined using the SHELXTL 2014 software suite. All non-hydrogen atoms were located from iterative examination of difference F-maps following which the structure was refined using least-squares method. Hydrogen atoms were placed geometrically in a riding model. Crystal Parameters: X-ray source: Mo-Kα; Crystal System: P6522; Unit Cell parameters: a=10.3578(3); b=10.3578(3); c=14.5744(5); α=90; β=90; γ=120; R1=4.4%; wR2=12.1%; GOF=1.05.

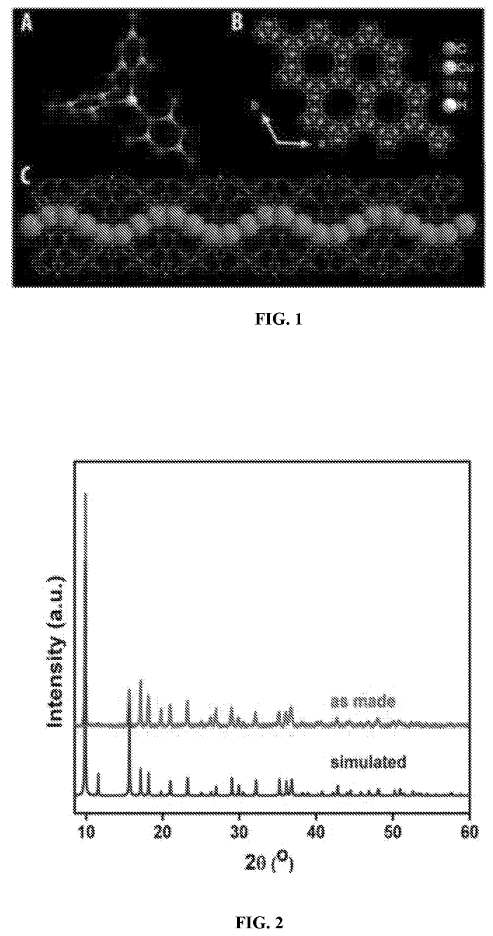

The structure solved from single crystal X-ray diffraction shows, (A) The trigonal coordination around the Cu(I) center by three melamine moieties. (B) Uniform 1-D channels in the IISERP-MOF22 (1) lined by the amine groups of the melamine. The free hydroxyl groups in the channels are not shown for clarity. (C) The structure of the MOF showing the view along a-axis wherein the ordered hydroxide ions in the channels are shown in red. Color code: Zn-cyan; C-grey; N-blue; O-red; H-white (FIG. 1)

### Powder X-Ray Diffraction Patterns:

The freshly prepared sample was washed with methanol and dried in an oven at 80° C. overnight before measuring the Powder X-ray diffraction pattern using a Cu-Kα radiation on a Rigaku Powder X-ray Diffraction system. FIG. 2 represents the results of the analysis.

### TGA Analysis:

The freshly prepared sample was filtered and dried in air overnight before performing the TGA analysis. In case of methanol soaked sample, the as made was sample was soaked in methanol for 3 days and the filtered and dried overnight. All the TGA analysis were performed under a flow of nitrogen (20 ml/min).

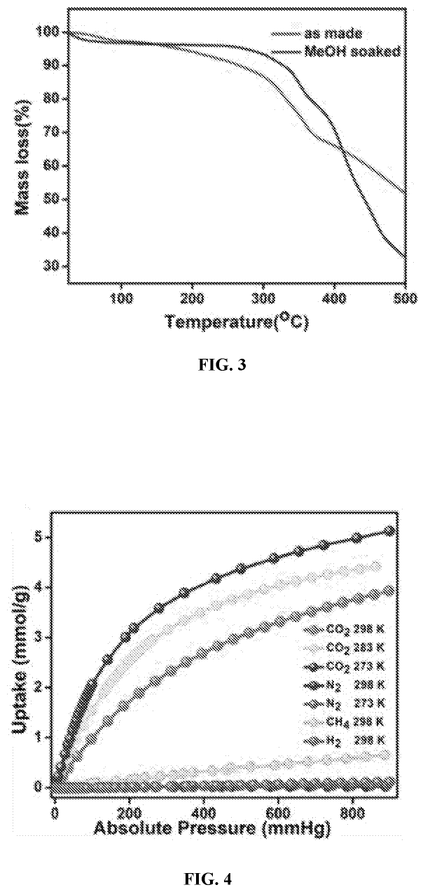

TGA carried out on the as-made MOF shows that there is 2.5% weight loss at 90° C. which is attributed to the solvent molecules residing on the surface. In the MeOH soaked sample, initial weight loss is due to the methanol residing on the surface. There is no weight loss after that, hence no solvent molecules are inside the pores. The material is thermally stable upto 280° C. (FIG. 3).

### Adsorption Isotherm:

The methanol soaked sample was activated by heating under vacuum at 130° C. for 24 hours before performing the adsorptions. All gases are at least 99.999 purity grade. The isotherms were measured on a Micromeritics ASAP2020 instrument. Amount of sample used=˜150 mg.

Adsorption isotherms carried on the 3D hydrophobic MOF (FIG. 4) showing Type I isotherms for CO₂ ad linear isotherms for N₂, H₂ and CH₄. From the pure component adsorption-desorption isotherms (0 to 1 bar) the CO₂ uptake (˜4 mmol/g at 298 K) is confirmed. The other gases do not adsorb in any appreciable amounts under the same conditions. The MOF can be regenerated by mere sweep of He or by evacuating at modest vacuum or by vacuum+heating (80° C.).

### Pore Width

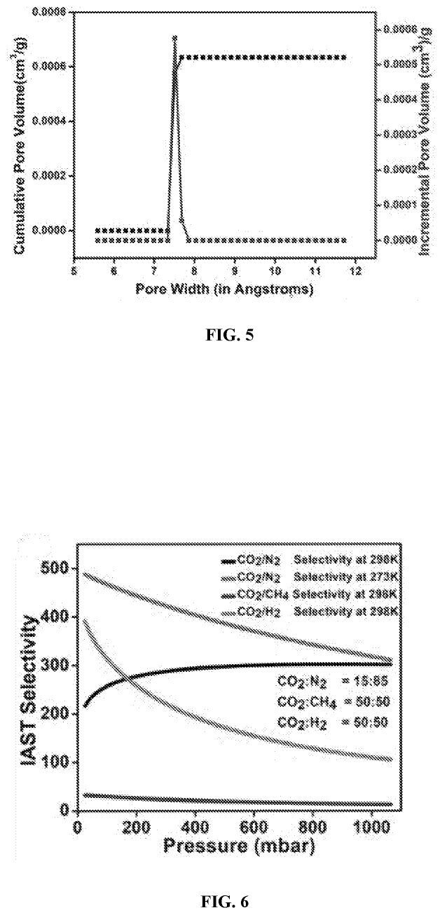

In another separate experiment, the Cu-MOF was treated with industrial flue gas composition (purchased) for over 24 hrs and the crystallinity and the porosity were intact. Pore width of the 3D hydrophobic MOF estimated by the NLDFT fit to the adsorption branch of 273K CO₂ isotherm is represented in FIG. 5.

### IAST Selectivity:

IAST selectivity by 3D hydrophobic MOF calculated for different gas mixtures is represented in FIG. 6. The selectivity for CO₂ over N₂ for example, is calculated using IAST method to be 300 for a 85% N₂+15% CO₂ composition.

### Heat of Adsorption:

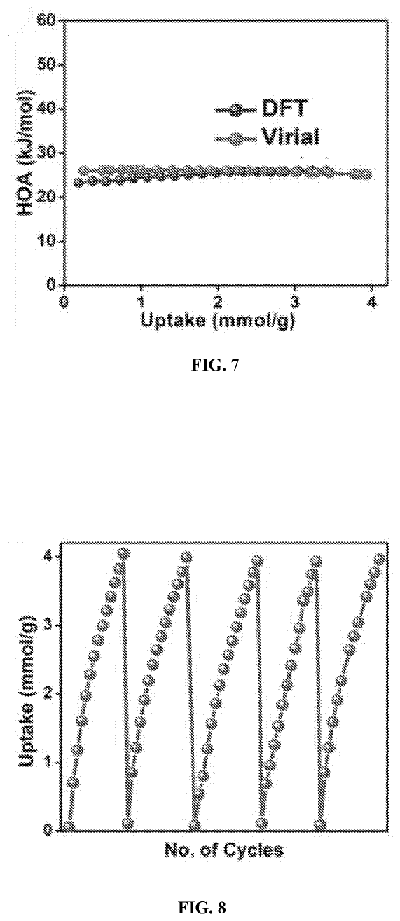

Heat of adsorption calculated for 3D hydrophobic MOF using two different methods. Moderate HOA of 25 KJ/mol can be very useful for the facile regeneration of MOF (FIG. 7).

### Recyclability of MOF:

The activated sample (˜150 mg) was used for performing consecutive cycles of adsorption-desorption where the sample was activated merely by vacuum (no heating) after each cycle. Volumetric CO₂ cycling performed on 3D hydrophobic MOF showing the recyclability of MOF (FIG. 8).

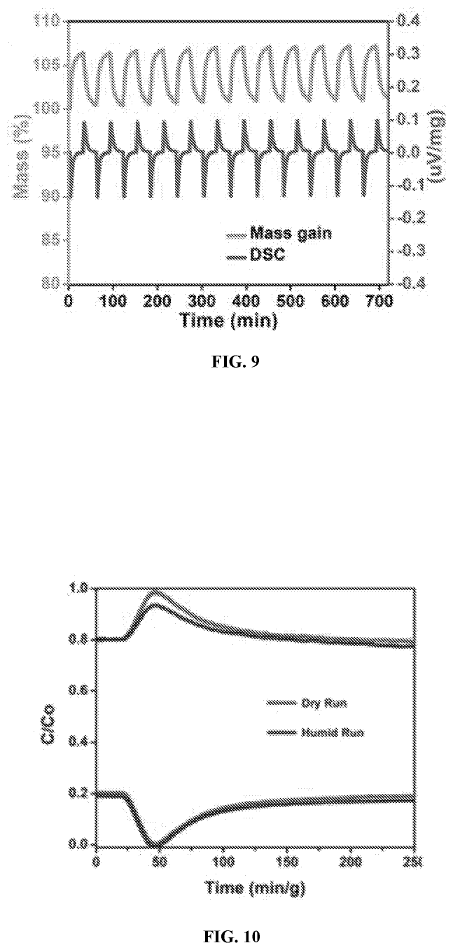

The CO₂ adsorption cycles have been verified through pure component volumetric equilibrium adsorption, volumetric isocycling and gravimetric cycling on a TGA setup. In the volumetric cycling, the sample has been saturated with CO₂ and then evacuated before being subjected to the next cycle and 5 such cycles have been performed without any loss of capacity. For the gravimetric cycling, the sample has been dozed with CO₂ to saturation and then the adsorbed CO₂ has been removed completely with a He sweep. Twelve such cycles were repeated without any loss of CO₂ capacity. All these cycling and equilibrium volumetric adsorptions (on a porosity analyzer instrument) were performed at room temperature. Gravimetric cycling experiment was performed by loading 20 mg of the activated sample in the Thermo-gravimetric analyzer and several cycles of adsorption-desorption were performed. In this experiment, the flow of CO₂ (20 ml/min) and N₂ (20 ml/min) was switched in regular intervals. CO₂ adsorption takes place during the CO₂ flow and then the N₂ flow is used to flush all the adsorbed CO₂. Gravimetric CO₂ cycling performed on 3D hydrophobic MOF showing the recyclability of MOF (FIG. 9).

Co₂/N₂ Breakthrough:

In a separate experiment, the ability of the MOF to separate CO₂ from a mixture containing CO₂/N₂ was performed using a Breakthrough Analyzer. Wherein a column containing the MOF was treated with the mixture. The selective adsorption of CO₂ and recovery was observed (˜3.3 mmol/g of CO₂ under dry conditions and 3.5 mmol/g of CO₂ under humid conditions (>75% humidity) are separated from a 85% N₂+15% CO₂ mixture, during a breakthrough run). The amount of CO₂ separated in this method remains the same between multiple runs.

CO₂/N₂ breakthrough carried on 3D hydrophobic MOF at a total flow rate of 25 ml/minute (20 ml CO₂+5 ml N₂). The breakthrough retention times were normalized per gram of the sample. The measurements were performed on a Rubotherm breakthrough analyzer employed with high resolution mass spectrometer for detection. Results are represented in FIG. 10.

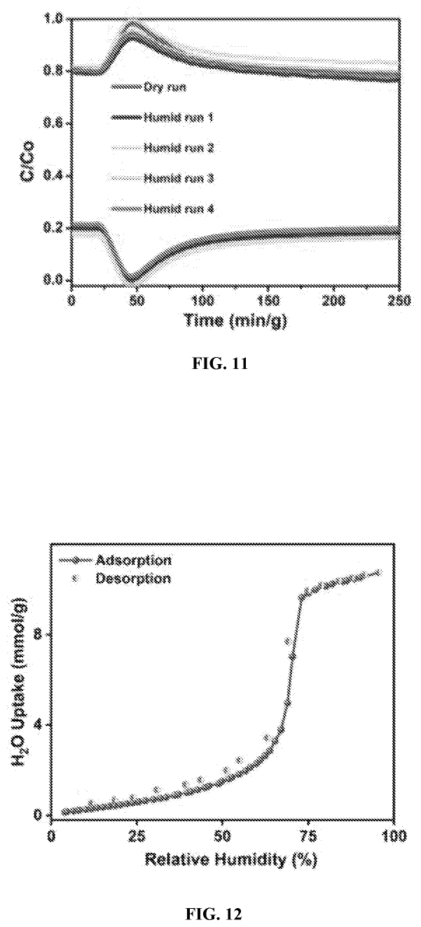

CO₂/N₂ breakthrough cycles showing no loss in the retention time after multiple cycles (FIG. 11).

Interaction with Water:

298 K Water sorption isotherm of 3D hydrophobic MOF showing the poor interaction of water molecules with the MOF (FIG. 12). Measurements were performed on a Micromeritics ASAP 2020 instrument.

### Stability of 3D Hydrophobic MOF:

The solutions of pH in the range of 1-14 were prepared and MOF was soaked into each solution (50 mg in 20 ml solution). The MOF was filtered and subjected to PXRD after 24 hours.

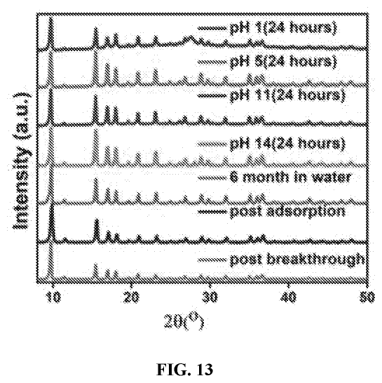

PXRD of the 3D hydrophobic MOF treated under different conditions showed exceptional stability of MOF (FIG. 13).

1. A re-usable three-dimensional hydrophobic amine-rich porous metal organic framework (3D hydrophobic MOF) with a high selectivity for CO₂ from humid atmospheres, said 3D hydrophobic MOF is characterized by the formula MN(ORG)(OH)·(SOLVENT) x,
wherein, MN is metal node-Cu(I); ORG is organic ligand-melamine; x is from 0 to 10 and SOLVENT is one or more of DMF,
wherein, the 3D hydrophobic MOF is characterized by trigonal coordination around the Cu(I) center by melamine moieties and Uniform 1-Direction channels in the 3D hydrophobic MOF lined by the amine groups of the melamine.

2. The 3D hydrophobic MOF as claimed in claim 1, wherein the 3D hydrophobic MOF is characterized by the formula Cu(C₃N₃H₆)(OH)·(DMF/H₂O)x, wherein, x is from 0 to 10.

3. The 3D hydrophobic MOF as claimed in claim 1, wherein the 3D hydrophobic MOF is characterized by the formula Cu(C₃N₃H₆)(OH)·(DMF)x·(H₂O)y, wherein, x is from 0 to 0.5 and y is from 0 to 0.2.

4. The 3D hydrophobic MOF as claimed in claim 1, wherein the Cu has +1 oxidation state.

5. The 3D hydrophobic MOF as claimed in claim 1, wherein the 3D hydrophobic MOF has an optimal concentration of charge-balancing hydroxide ions in the pores to ensure >3 mmol/g of CO₂ uptake at room temperature with a CO₂/N₂ selectivity of ˜300, and remains the same for zero to >3 mmol of CO₂.

6. The 3D hydrophobic MOF of claim 1, wherein 3D hydrophobic MOF is stable up to 280° C.

7. A method of synthesizing a re-usable three-dimensional hydrophobic amine-rich porous metal organic framework (3D hydrophobic MOF), said method comprising the steps of:
effecting a solvothermal reaction between copper nitrate trihydrate, melamine, and terephthalic acid in organic solvent, followed by cooling to room temperature to obtain reaction product;
filtering reaction product to obtain block shaped pale green crystals of 3D hydrophobic MOF;
sonicating the block shaped pale green crystals in organic solvent, followed by filtering to remove unreacted terephthalic acid; and
washing with copious amounts of alkanol to obtain the 3D hydrophobic MOF.

8. The method as claimed in claim 7, wherein the ratio of copper nitrate trihydrate and melamine is 0.1:1 to 1:0.1, respectively.

9. The method as claimed in claim 7, wherein the ratio of copper nitrate trihydrate and melamine is 1:1, respectively.

10. The method as claimed in claim 7, wherein the ratio of copper nitrate trihydrate and melamine is 0.1 mmol: 0.1 mmol, respectively.

11. The method as claimed in claim 7, wherein the concentration of terephthalic acid is 0.1-1 mmol.

12. The method as claimed in claim 7, wherein the solvothermal reaction is effected at 90° C. to 150° C. for 48 hrs to 96 hrs.

13. A method for sorbing CO₂ form humid atmospheres, said method comprises the steps of:
contacting the 3D hydrophobic MOF of claim 1 with a fluid or gas stream containing H₂O, CO₂, CH₄, N₂, H₂, and the like, wherein CO₂ is sorbed on the MOF; and
optionally regenerating the 3D hydrophobic MOF for next CO₂ sorbing cycle.
